(19) United States
(12) Patent Application Publication
(10) Pub. No.: US 2002/0169758 A1
(43) Pub. Date: Nov. 14, 2002

(54) Apparatus and methods for reducing compression and decompression time in a computer system

(76) Inventor: Arman Toorians, San Jose, CA (US)

Correspondence Address: Claudia Cameron, Phoenix Technologies Ltd., 411 East Plumeria Drive, San Jose, CA, 95134, US

(21) Appl. No.: 09/855,007

(22) Filed: May 14, 2001

(51) Int. Cl. G06F 7/00; G06F 17/30

(52) U.S. Cl. 707/3; 708/203

(57) ABSTRACT

Apparatus and methods for reducing compression and decompression time in a computer system that selectively compresses only the data space of a storage medium 16 used for data storage without having access to internal data structures of the operating system or file system. The present invention reduces the compression and decompression time of a given data storage medium in the computer system. Compression and decompression algorithms selectively exclude a portion of the storage medium that it marks as unused space. This reduces the total time that is needed to compress and decompress the data on a storage medium that has both usable and unused data on the storage medium.

### BACKGROUND

The present invention relates generally to computer systems and methods, and more particularly, to a method for reducing compression and decompression time in a computer system.

Prior art compression and decompression algorithms provide many ways of compressing data. There are many patents that describe these methods. In known prior art methods, compression is applied to a file or a directory or the whole storage medium. However, known prior methods do not have the intelligence to selectively compress only the used data space of storage medium without looking at the file system used data space information.

It is therefore an objective of the present invention to provide for a method for reducing compression and decompression time in a computer system without having access to the file system during the compression and decompression operation. It is also an objective of the present invention to provide for a method for reducing compression and decompression time in a computer system that selectively compresses only the data space of a storage medium that is used regardless of the type of operating system installed in the storage medium and without information about internals of the operating system or file system.

### SUMMARY OF THE INVENTION

To accomplish the above and other objectives, the present invention provides for a method for reducing compression and decompression time in a computer system that selectively compresses only the data space of a storage medium that is used for data storage. An exemplary method comprises the following steps.

A storage medium is formatted. An operating system is installed on the formatted storage medium. Additional applications and/or drivers are loaded onto the storage medium.

A compression algorithm is executed that searches the storage medium for a predetermined pattern or signature that identifies or marks unused space on the storage medium. If the pattern or signature already exists, the compression algorithm notifies a user or changes the pattern or signature to a different pattern that does not exist on the storage medium.

The compression algorithm then requests the operating system to make available one or more files, and preferably the largest possible file, that will occupy the entire unused space on the storage medium. If the operating system does not have the capability to create one file that consumes the entire unused space on the storage medium, then many files are requested until the operating system cannot open more files due to lack of space on the storage medium.

The one or more files (comprising one large file or many small files) are then filled with the pattern or signature that is recognizable by the compression algorithm. The one or more files are deleted from the directory entry of the storage medium, leaving the pattern or signature on the medium, but making the space available to the operating system.

Compression is then performed on the storage medium using the compression algorithm. When the compression algorithm encounters the pattern or signature written on the medium identifying it as unused space, it ignores that storage space and registers it as unused space.

The decompression algorithm then decompresses the compressed image back onto the storage medium. When the decompression algorithm encounters each pattern or signature, it ignores them and does not write that data onto the storage medium.

The present invention thus reduces the compression and decompression time of a given data storage medium such as hard disk drive or floppy drive, for example, in a computer system. By utilizing the present invention, a compression and decompression algorithm selectively excludes a portion of the drive that it marks as unused space without having access to internals of an operating system file system. This reduces the total time that is needed to compress and decompress the data on a storage medium that has both usable and unused data on the storage medium. This method can be applied to a storage medium with any operating system and is not operating system dependent.

### BRIEF DESCRIPTION OF THE DRAWINGS

The various features and advantages of the present invention may be more readily understood with reference to the following detailed description taken in conjunction with the accompanying drawing, wherein like reference numerals designate like structural elements, and in which:

FIG. 1 is a block diagram showing apparatus in accordance with the principles of the present invention for reducing compression and decompression time for data residing a storage medium; and

FIG. 2 is a flow diagram illustrating an exemplary method in accordance with the principles of the present invention for reducing compression and decompression time in a computer system.

### DETAILED DESCRIPTION

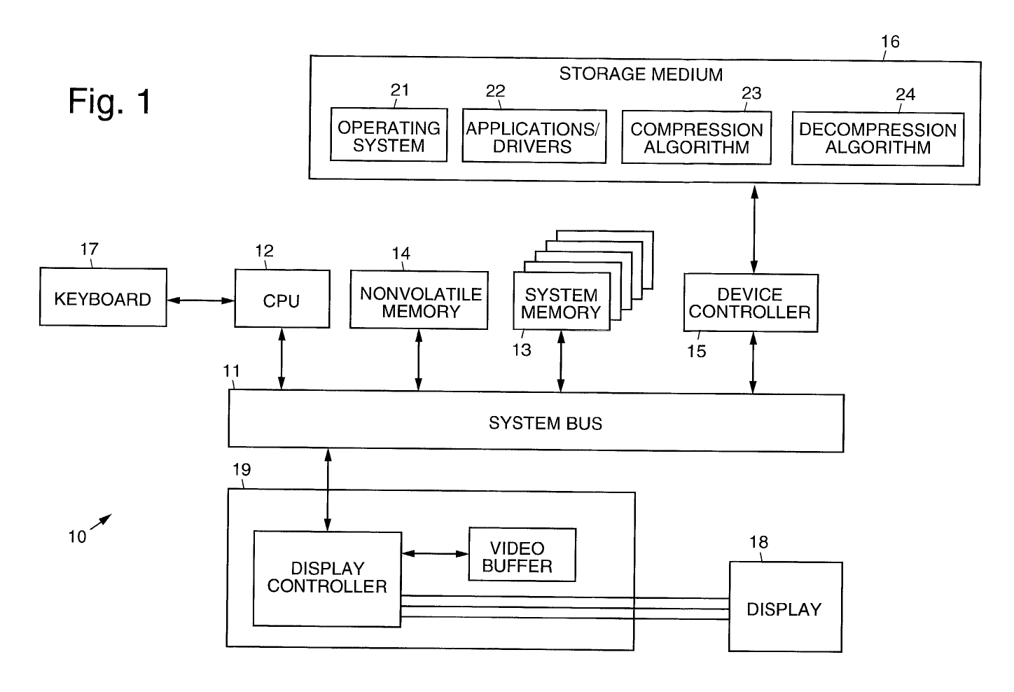

Referring to the drawing figures, FIG. 1 is a block diagram showing apparatus 10 comprising a computer system 10 in accordance with the principles of the present invention that reduces compression and decompression time for data residing on a formatted storage medium 16. The computer system 10 includes a system bus 11 that connects components of the computer system 10 including a central processing unit (CPU) 12, a system memory 13, and a nonvolatile memory 14 (or flash memory 14).

Data is stored on the formatted storage medium 16. Data may be stored on the storage medium 16 which is accessed by the CPU 12 through a device controller 15. Other standard components of the computer system 10 include a data input device 17, such as a keyboard 17, and a data display device 18 that is connected to the system bus 11 through a video controller 19 that includes a video buffer.

The storage medium 16 may be a hard disk drive, Zip drive, a magneto-optical drive, a rewritable compact disk, a superdisk, a high density floppy disk, or a solid state disk drive, for example. The nonvolatile memory 14 may be a flash device, an EPROM, an EEPROM, PROM, a zero power RAM device, or a battery backup RAM device, for example.

The formatted storage medium 16 has an operating system 21, along with applications 22 and/or drivers 22 disposed thereon. Compression and decompression algorithm 23, 24 are disposed on the formatted storage medium 16 or are disposed in the nonvolatile memory 14.

The compression algorithm 23 is used to search the storage medium 16 for a predetermined pattern or signature and marks unused space on the storage medium 16 using the pattern or signature. The compression algorithm 23 is used to request the operating system 21 to create one or more files that occupy the entire unused space on the storage medium 16. The compression algorithm 23 is used to fill the one or more files with the pattern or signature that is recognizable by the compression algorithm 23. The compression algorithm 21 is used to delete the one or more files from the directory entry of the storage medium 16, leaving the pattern or signature on the medium 16, and making the space available to the operating system 21. The compression algorithm 23 is also used to compress the data on the storage medium 16. The decompression algorithm 24 is used to decompress the compressed image and write it back onto the storage medium 16.

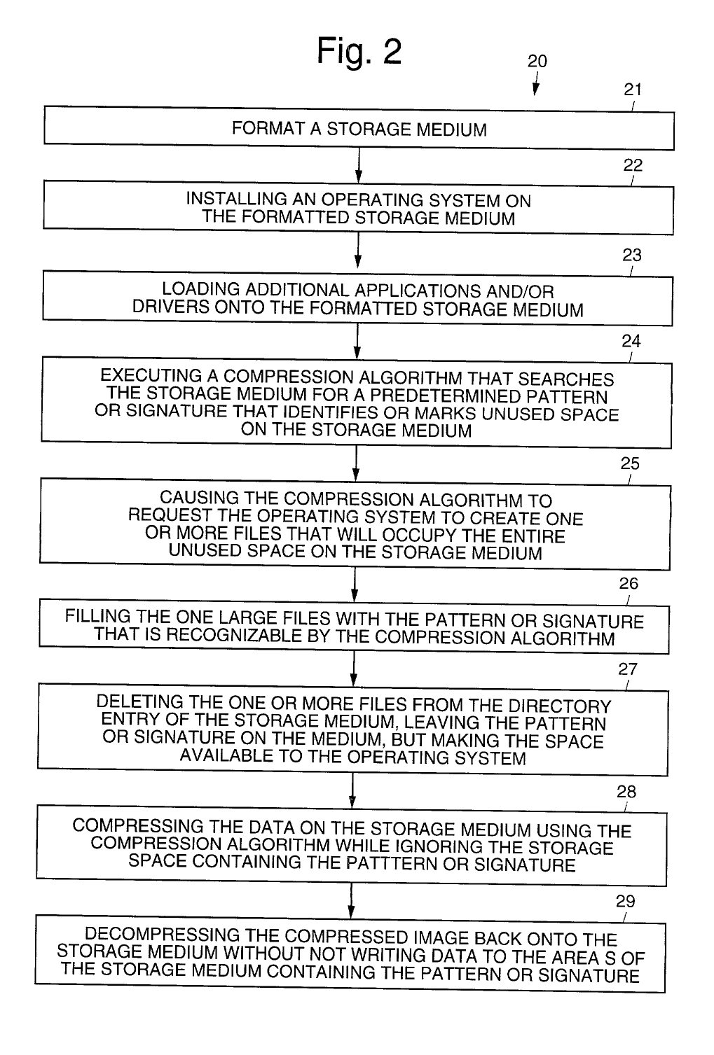

FIG. 2 is a flow diagram illustrating an exemplary method 30 in accordance with the principles of the present invention for reducing compression and decompression time in a computer system 10 having a storage medium 16 having data stored on a portion thereof. The exemplary method 30 comprises the following steps.

A storage medium 16, such as a hard disk drive 16, for example, is formatted 31 and prepared for installation of an operating system 23. The operating system 23 is installed 32 on the formatted storage medium 16. Additional applications and/or drivers 22 are loaded 33 onto the storage medium 16.

Then a compression algorithm 23 or routine is executed 24 that searches the storage medium 16 for a predetermined pattern or signature and marks unused space on the storage medium 16 using the pattern or signature. An exemplary pattern or signature is known as PTEC. If the pattern or signature already exists, the compression algorithm notifies a user or changes the pattern or signature to a different pattern that does not exist on the storage medium 16.

The compression algorithm 23 then requests 35 the operating system 21 to create one or more files that occupy the entire unused space on the storage medium 16. It is preferred that the operating system 21 to create the largest possible file that occupies the entire unused space. If the operating system 21 does not have the capability to create one file that consumes the entire unused space on the storage medium 16, then many files are requested until the operating system 21 cannot open more files due to lack of space on the storage medium 16.

The one or more files (comprising the one large file, or plurality of files) are then filled 36 with the pattern or signature that is recognizable by the compression algorithm 23. The one or more files are deleted 37 from the directory entry of the storage medium 16, leaving the pattern or signature on the medium, but making the space available to the operating system 21.

The data on the storage medium 16 is then compressed 38 using the compression algorithm 23. When the compression algorithm 23 encounters the pattern or signature that was written on the storage medium 16 identifying it as unused space, it ignores that storage space and registers it as unused space.

The compressed image is then decompressed 39 using the decompression algorithm 24 and written back onto the storage medium 16. When the decompression algorithm 24 encounters each of the patterns or signatures, it ignores them and does not write that data onto the storage medium 16.

One application of the present invention is that it may be used by computer system 10 manufacturers to save the original manufacturer's hard drive image. Then, only the used data space on the original hard drive image can be restored quickly upon a user's request. This is accomplished by compressing the original useful data that has been installed in a hard disk drive 16 (such as the operating system 21 and necessary applications 22) and leaving out the space that has been marked as unused space.

On most computer systems 10, the ratio of unused space to used space is greater than about 30 to 1. Therefore, using the compression and decompression algorithms 23, 24 to identify the unused space on the storage medium 16 causes compression and decompression of data on the storage medium 16 to be much faster than is conventionally achievable. Use of the method makes both compression and decompression of a 30 gigabyte drive that contains only 1 gigabyte of software, for example, much faster.

Thus, apparatus and methods for reducing compression and decompression time in a computer system have been disclosed. It is to be understood that the above-described embodiments are merely illustrative of some of the many specific embodiments that represent applications of the principles of the present invention. Clearly, numerous and other arrangements can be readily devised by those skilled in the art without departing from the scope of the invention.

What is claimed is:

1. A method for reducing compression and decompression time in a computer system without having access to internals of the operating system file system, the method comprising the step of:
formatting a storage medium;
installing an operating system on the formatted storage medium;
loading additional applications and/or drivers onto the storage medium;
running a compression algorithm that searches the storage medium for a predetermined pattern or signature and marks unused space on the storage medium using the pattern or signature;
requesting the operating system to create one or more files that occupy the entire unused space on the storage medium;
filling the one or more files with the pattern or signature that is recognizable by the compression algorithm;
deleting the one or more files from the directory entry of the storage medium, leaving the pattern or signature on the medium, and making the space available to the operating system;
compressing the data on the storage medium using the compression algorithm; and
decompressing the compressed image using a decompression algorithm and writing it back onto the storage medium.

2. The method recited in claim 1 wherein the step of requesting the operating system to create one or more files comprises the step of causing the compression algorithm to request 35 the operating system to create the one or more files.

3. The method recited in claim 1 wherein the operating system creates the largest possible file that occupies the entire unused space of the storage medium.

4. The method recited in claim 2 wherein the operating system creates a plurality of files that occupy the entire unused space of the storage medium.

5. The method recited in claim 1 wherein, when the compression algorithm encounters the pattern or signature written on the storage medium identifying it as unused space, it ignores that storage space and registers it as unused space.

6. The method recited in claim 1 wherein, when the decompression algorithm encounters each pattern or signature, it ignores it and does not write that data onto the storage medium.

7. Apparatus comprising:
a computer system including a formatted storage medium 16 having an operating system and applications and/or drivers on the storage medium;
a compression algorithm disposed on the computer that searches the storage medium for a predetermined pattern or signature and marks unused space on the storage medium using the pattern or signature, that requests the operating system to create one or more files that occupy the entire unused space on the storage medium, that fills the one or more files with the pattern or signature that is recognizable by the compression algorithm, that deletes the one or more files from the directory entry of the storage medium, leaving the pattern or signature on the medium, and making the space available to the operating system, and that compresses the data on the storage medium using the compression algorithm; and
a decompression algorithm disposed on the computer that decompresses the compressed image and writes it back onto the storage medium.

8. The apparatus recited in claim 7 wherein the compression algorithm requests the operating system to create the one or more files.

9. The apparatus recited in claim 7 wherein the operating system creates the largest possible file that occupies the entire unused space of the storage medium.

10. The apparatus recited in claim 7 wherein the operating system creates a plurality of files that occupy the entire unused space of the storage medium 16.

11. The apparatus recited in claim 7 wherein, when the compression algorithm encounters the pattern or signature written on the storage medium identifying it as unused space, it ignores that storage space and registers it as unused space.

12. The apparatus recited in claim 7 wherein the decompression algorithm encounters each pattern or signature, ignores it and does not write that data onto the storage medium.
